(19) United States
(12) Patent Application Publication
(10) Pub. No.: US 2015/0321505 A1
(43) Pub. Date: Nov. 12, 2015

(54) Artist Palette, Paint Storage, Preservation and Compositional System

(71) Applicant: Amy L. Carter, Cannon Falls, MN (US)

(72) Inventor: Amy L. Carter, Cannon Falls, MN (US)

(21) Appl. No.: 14/703,569

(22) Filed: May 4, 2015

Related U.S. Application Data
(60) Provisional application No. 61/989,865, filed on May 7, 2014.

(51) Int. Cl. B44D 3/02; B65D 81/18; B44D 3/00

(52) U.S. Cl. CPC B44D 3/02; B44D 3/003; B65D 81/18

(57) ABSTRACT

This invention, integrates and combines artists functions; is both a stand-alone and companion product in near custom fits for many, various sized pochade easels. It simultaneously functions as an all in one, optimally sized acrylic or similarly transparent; smooth, undivided palette tray in materials oil and outdoor painters need and as a paint storage/preservation device that withstands freezing temperatures; eliminates the transfer of unused paint; and as a tool to apply color mixes, evaluating them directly to artists subject, visible through the transparent cover that also affords instant visibility of palette's current pigment load. Its Value and Color Isolator, readily aids in assessments and comparisons of artist subject and finished paintings. Meaningful changes and improvements in materials and sizes along with the combination of additional functions makes artists work easier with almost effortless strategy for preserving unused paint, thus reducing paint waste, benefitting the environment and artists pocketbook.

### CROSS REFERENCE TO RELATED APPLICATIONS

The application listed below is the only application related to this application. This application claims benefit of the earlier filing date under 35 USC 119(e) of provisional application No. 61/989,865 filed on May 7, 2014.

### BACKGROUND OF THE INVENTION

1. Field of the Invention

The invention which is the subject of this application relates to the field of artist supplies and tools.

2. Description of Related Art

The invention is both a stand-alone and companion product that works with the multitude of various sizes of Pochade style easels on the market. Pochade style easels are well known in the art of “Plein Air” painting.

Plein air (translates “open air”) painting, otherwise referred to as outdoor painting, is booming in popularity and related product sales. And yet no product is available that actually meets the needs of oil painters and/or plein air painters. So called similar palette trays are actually functional with acrylics but they are particularly unsuited to working with oil paints and they do not make optimal use of the palette area (prime real estate for artists) of pochade style easels. Pochade box or referred to as pochade style easels are very popular portable easels. These easels typically utilize a portable wooden brief case style apparatus that attaches to a tripod. The case opens and holds a canvas panel on the upper vertical portion and the lower portion of the pochade box provides the palette space.

Limitations and Problems Associated With Prior Art/Existing Related Products include that:

Most existing related products are made of opaque materials (such as plastic or aluminum) that are not transparent and do not provide the ability to directly match artists custom paint mixes to the subject as seen through the tray cover or base/bottom or preservation device of existing prior art products.

Most existing related products are made of opaque materials that do not provide the ability to see their subject through their device to use it a compositional tool.

Most existing related products are made of opaque materials and do not provide the ability for the artist to assess the status of pigments loaded on the palette without removing the cover.

Existing related prior art are not made in the actual material most preferred and used by oil painters and plain air painters, which is the acrylic sheet material artists currently cut to size and insert into pochade box easels.

Many existing related prior art palette trays with covers are made of common plastics that tend to crack or break from freezing temperatures when these existing trays are used as preservation devices in a freezer.

Most existing related prior art palette trays are comprised of divisions including numerous wells-meant to hold acrylic paint or water color but these wells are not conducive to working with oil paints. The divisions get in the way of how oil painters typically slide paint down from pigment piles into custom mixed paint pools on the central area of the palette. Furthermore, oil paint builds up and is then difficult to remove from these wells.

Existing related prior art palette trays that rely on the removal of unused paint by simply peeling off the dried acrylic, work well for acrylics but not oil paints. This type of existing related prior art does not work well to peel off oil paints and the existing (plastic) prior art does not stand up to metal palette knives typically used to remove dried oil paint.

Many existing related prior art palette trays made of common plastic often stain from artists pigments thus not providing a clean, neutral palette area for paint mixing.

Most existing related prior art palette trays are made of opaque materials with multiple divisions and wells for water based paints and it has been suggested that to use their product with oils, one may insert a disposable palette paper. However, in practice the palette paper frequently slips out of place and it does not hold up particularly well to the use of metal palette and painting knives that are commonly used with oil paints.

Related prior art existing palette trays that rely on the use of a wet sponge within a closed container (for the preservation of paint) tends to mold/mildew and become noxious with odors.

Most existing related prior art palette trays do not make optimal use of the available palette area within pochade box style easels which are offered in a multitude of sizes. Most existing palette trays do not fully or near fully fill the available palette area within these pochade box easels thus reducing the working palette space when the existing trays are inserted into the pochade box easel. Because most artists typically won't sacrifice palette area, these existing trays are left to function as storage/preservation trays that often are not long used for this purpose because it involves the transfer of unused paint piles both back and forth, to and from the smaller tray and the acrylic sheet typically installed as the working palette in pochade box easels.

### BRIEF SUMMARY OF THE INVENTION

The Artist Palette, Paint Storage, Preservation and Compositional system 1 is an integrated system/combination tool for the needs of artists that modifies and improves upon prior art. The invention is both a stand-alone and companion product that works with the multitude of various sizes of pochade style easels on the market.

Pochade style easels are very popular with artists in classroom settings and for outdoor painting due to their portability. Individual artists often own and use several easels in various sizes.

Preferably, the use of optically clear impact modified acrylic or general grade acrylic sheet or similar materials is indicated due to the combination of properties which allow it to simultaneously function as a palette surface as well as for paint storage and preservation 1. The use of preferably, impact modified acrylic, or general purpose acrylics and or other clear materials in the Artists Palette, Paint Storage, Preservation and Compositional System 1 is a significant improvement in materials that eliminates the need to transfer unused paint back and forth between the acrylic sheet artists prefer as a working palette and a separate prior art device. Acrylic sheet is optically clear, impact and weather durable, is the preferred working palette 5 surface for painters and it can be formed into a multitude of shapes including preferably, a full sized palette that also acts as the storage and preservation device 1. The combination of material properties of preferably, impact modified or general purpose acrylics or other similar optically clear materials, indicates the use of these materials in a product that simultaneously functions as the artists palette and paint storage and preservation device 1.

The present invention, Artist Palette, Paint Storage, Preservation and Compositional System provides solutions to the shortcomings of existing related prior art including that:

The present invention is intentionally to be preferably made in a multitude of dimensions to maximize the use of the available palette area within the multitude of sizes of pochade box easels being offered on the market. As such, the present invention provides a seamless, easy transition from functioning as the working palette to functioning as the storage and preservation device without the cumbersome, time consuming transfer of paint piles. There is one known existing related palette tray that is sized to fit in a large 12×16 pochade box easel but with its cover attached, the pochade box cannot be closed thus it is not transportable within the pochade box. It is also a product with many divisions and wells and is made of opaque materials and as such is not compatible with oils.

The present invention provides solutions to the shortcomings of existing related prior art and provides new and combined functions and improved capabilities that culminate in a new product that fulfills unmet needs for artists, particularly so for oil painters and plein air painters. Because of the material improvements including increased durability in freezing temperatures, this present invention works very well in the preservation of oil paint and acrylic paints as preserved in a typical household freezer. The use of optically clear materials comprising this present invention provide a new, convenient function of allowing the artist to instantly assess the pigment status of their palette without removing and later replacing the tray cover. The use of optically clear materials of this present invention also provide new functions of providing a way for artists to mix and directly compare their paint mixes for color matching against the actual subject they view through the clear tray cover. The use of optically clear materials enable the use of the tray cover as a compositional tool—a function not afforded by opaque materials. The application of the Value and Color Isolator on this present invention's clear cover and on a wooden strip form or similar material, provide additional functions of the present invention over prior art existing palette trays. What cannot be overstated is the crucial difference it will make when this present invention is intentionally made in a multitude of corresponding dimensions that correlate to and make optimal use of the available palette area within the multitude of sizes of pochade box easels offered on the market. This vital feature meets an imperative unmet need in the industry for artists, particularly plein air and oil painters, because it effectively provides the ideal working palette (size and preferred material) and paint storage and preservation device as one combined product that makes their work easier and saves them time and money via the significant reduction of wasted paint, not to mention the environmental impact of wasted paint being thrown away vs. preserved and used.

This present invention's changes and improvements in materials and sizes provide essential qualities that are vital to oil and plein air painters, constituting far more than ‘a mere change in size or improvement upon prior art’. Ultimately, the culmination of all these changes and improvements in materials and sizes along with the addition and combination of additional functions in this present invention has far reaching effects and most assuredly meets unmet needs of artists—and, does so in ways not previously anticipated.

### BRIEF DESCRIPTION OF THE SEVERAL VIEWS OF THE DRAWING

FIG. 1 is an interior cutaway view of the Artist Palette, Paint Storage, Preservation and Compositional System in use with artist using the Value and Color Isolator in its wooden strip embodiment to evaluate paint mix values in the same light as their painting canvas (above) and palette (below).

FIG. 2 is a top view of the Artist Palette, Paint Storage, Preservation and Compositional System open and in use being prepared for painting or storage or transportation with the application of artist pigments from large economy tubes.

FIG. 3 is an perspective view of the Artist Palette, Paint Storage, Preservation and Compositional System opened and seen making optimal use of the palette area within a pochade box easel.

FIG. 4 is a perspective view of the Artist Palette, Paint Storage, Preservation and Compositional System within a pochade box easel, showing the palette tray with pigments and previous paint mixes immediately ready for use when the pochade easel is opened.

FIG. 5 is a perspective view of the Artist Palette, Paint Storage, Preservation and Compositional System's tray cover with its Value and Color Isolator in use with the artist's subject 6 as seen through the clear tray cover 3.

FIG. 6 is a perspective view of the Artist Palette, Paint Storage, Preservation and Compositional System showing the placement of several pigment piles.

FIG. 7 is a perspective view of the top and bottom portions of the Artist Palette, Paint Storage, Preservation and Compositional System.

FIG. 8 is a top view of the value and color isolator.

FIG. 9 is a perspective view of the Artist Palette, Paint Storage, Preservation and Compositional System's clear tray cover being use to apply and compare artist paint mixes directly upon the colors of their subject (hillside) as seen through the clear tray cover.

### DETAILED DESCRIPTION OF THE INVENTION

The Artist Palette, Paint Storage, Preservation and Compositional system 1 is an integrated system/combination tool for the needs of artists that modifies and improves upon prior art. The invention is both a stand-alone and companion product that works with the multitude of various sizes of pochade style easels on the market.

Pochade style easels are very popular with artists in classroom settings and for outdoor painting due to their portability. Individual artists often own and use several easels in various sizes.

Preferably, the use of optically clear impact modified acrylic or general grade acrylic sheet or similar materials is indicated due to the combination of properties which allow it to simultaneously function as a palette 5 surface as well as for paint storage and preservation 1. The use of preferably, impact modified acrylic, or general purpose acrylics and or other clear materials is a significant improvement in materials that eliminates the need to transfer unused paint back and forth between the working palette and a separate preservation device. Acrylic sheet is optically clear, impact and weather durable, is the preferred working palette 5 surface for painters and it can be formed into a multitude of shapes including preferably, a full sized palette 5 that also acts as the storage and preservation device 1. The combination of material properties of preferably, impact modified or general purpose acrylics or other similar optically clear materials, indicates the use of these materials in a product that simultaneously functions as the artists palette 5 and paint storage and preservation device 1.

Acrylic sheet is more durable and weather resistant than most other plastics, making it preferable for the outdoor use of plein air painters. General purpose/general grade acrylic sheet is reportedly 2 to 3 times more impact resistant than double strength window glass and about 4 to 5 times more impact resistant than wire glass or other glasses. Impact modified acrylics have even more impact resistance strengths for example, ranging from 5 to 6 times (40% impact modified) up to 10 times (100% impact modified) stronger than general purpose acrylic; and 10 to 15 times (40%); up to 20 to 30 times (100%) stronger than double strength window glass; and 20 to 30 times (40%) up to 40 to 50 times (100%) stronger than polished wire glass or other glasses. The impact modified acrylic sheet used in this invention prototype can withstand temperatures down to −20 degrees Fahrenheit and its softening point is reportedly 210 degrees Fahrenheit.

Almost every oil or outdoor painter I have encountered uses a cut of general grade acrylic sheet that they insert into their pochade box—because it offers the ideal and is almost always, the only palette surface used by oil painters and plein air artists. Smooth undivided acrylic sheet is the ideal surface for oil (and other paints) painting with brushes because it permits the gentle pull, with a brush, and sliding down of paint from pure pigment piles 4, that are laid out along the palette's outer edge, down into artist custom paint mixes 7 in the more central area of the palette 5. Acrylic sheet is also the ideal surface for oil and other paint because it holds up well to the use of metal palette knives which are used to pick up paint; to mix paint and to scrape and remove wet or dried paint. Acrylic sheet cleans up well and doesn't lose optical clarity as it does not leave pigment stains behind that may happen with other plastics. Also, acrylic sheet holds up well to the use of odorless mineral spirits and metal palette knives that are used to clean up wet paint and or plain soap and water. Acrylic sheet stands up well to steel wool, oven cleaner and freezing. A freezing method of preservation, such as in a household freezer, is contemplated because the freezing temperatures slow the oxidation of the paint, prolonging the soft, workable quality of oil paint.

This invention fulfills numerous unmet needs for artists, and particularly so for oil painters and plein air painters. Some other products do not perform satisfactorily with oil paint because the material qualities that are advantageous for acrylic paint are quite different from the material qualities indicated in the use of oil paints as well as other paints, such as open acrylics and water mixable oils used in outdoor painting.

The Artist Palette, Paint Storage, Preservation and Compositional system 1, provides new and combined functions and improved capabilities. This invention fixes and makes easier, artists needs and tasks, including additional features that integrate more art tasks/functions into one product/artists tool, functions that haven't previously been put together particularly in the palette material most frequently used by oil and plein air painters. Additionally, because the invention is preferably, simultaneously a clear, *near custom fit palette, storage and preservation system, it makes saving unused paint for future use very convenient and efficient and eliminates the need to transfer unused paint back and forth between the acrylic sheet palettes artists prefer and some other paint storage and preservation device that does not make optimal use of the available palette area in various sized pochade box easels, nor make use of the artist preferred acrylic sheet materials. It also provides artists using acrylics a method of unused paint preservation between painting sessions that does not involve using water in a closed container at room temperature which tends to result in mold growth and noxious odors. *near custom fit meaning fitting a given category of pochade boxes (for example, 12×16 or 11×14) in such a way as to make optimal use of the available palette area inside that pochade box.

The product is preferably made both to fit into the interior of pochade boxes* (with the cover on the tray) and to simultaneously provide optimal use of the palette mixing area, are major factors that meet unmet needs in the industry. The intentional sizing and the product material that is of nearly exclusive preference among oil painters and plein air painters (using oil paints and in less frequency, acrylic paints, including open acrylics), goes directly to meeting unmet needs of artists. This invention allows artist to perform more functions and meets the needs of artists that have not been sufficiently met in the industry and certainly not in any one given tool.

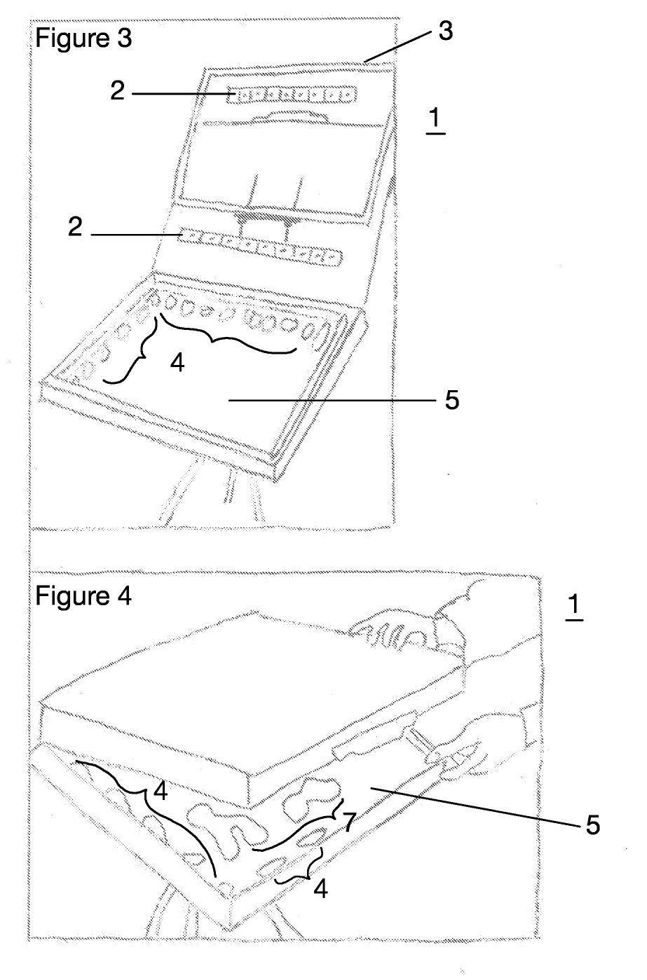

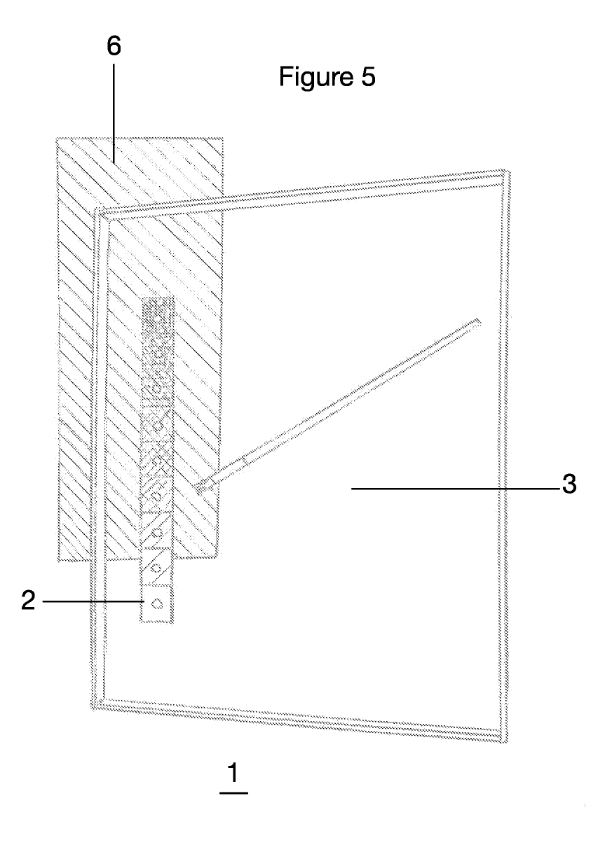

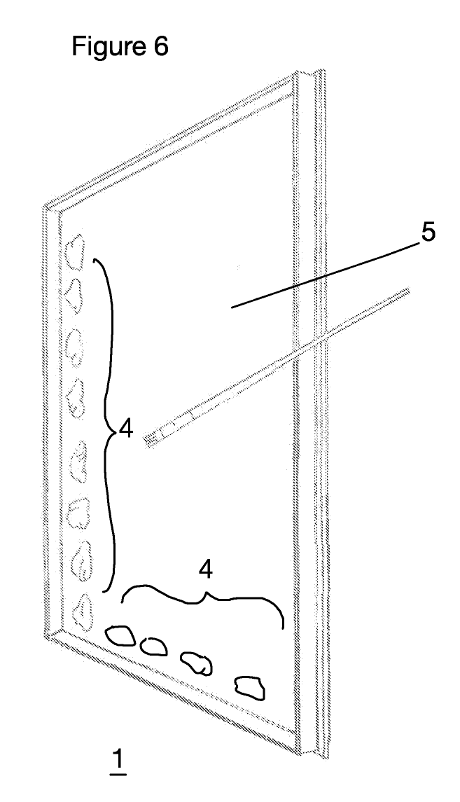

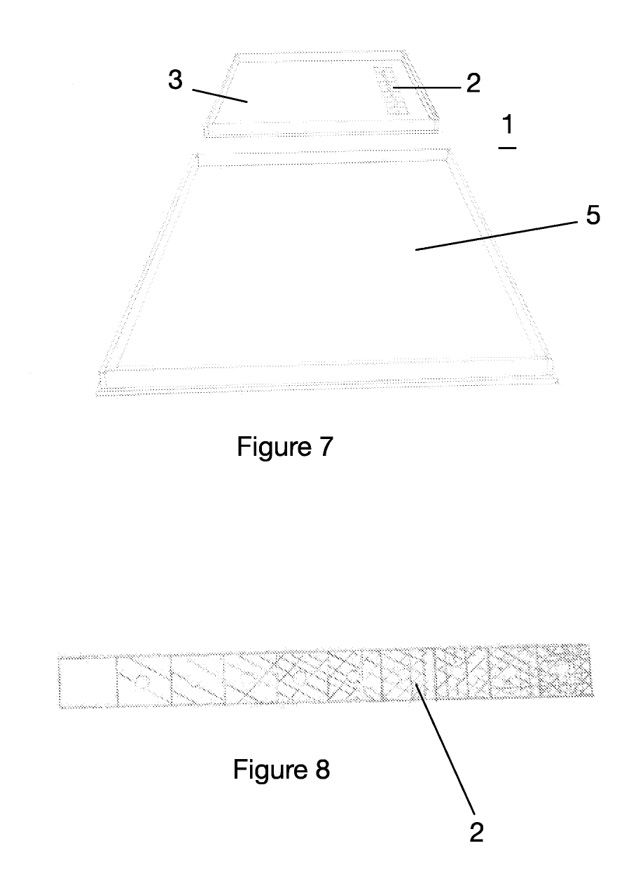

It is the combination and added features and functions including significant improvement in materials and the intentional sizing to preferably maximize the use of the full pochade palette area FIG. 3 and including the Value and color isolator 2, and the optically clear cover 3 that provides clear visibility for assessing palette status of pigment piles 4 and artist custom paint mixes 7; and, to explore value and compositional sketches. This invention also saves time when it's needed most—at the start of paint session and it makes preserving and reusing unused paint very easy by eliminating the need to transfer paint piles to and from palette and a storage/preservation device.

### What it is:

The Artist Palette, Paint Storage, Preservation and Compositional system 1 is a stand-alone or companion product. The invention is an optically clear acrylic, or similar material, tray that has a uniform fitting clear cover. The tray with the cover attached stores and preserves paint on the working palette under various environmental conditions such as, room temperature, freezing temperatures etc. The tray cover has an artists 9 step value scale 2 applied to it. The 9 step value scale has small, centrally located visibly clear viewing circles (sometimes referred to as holes). The viewing circles or holes may vary in size, thickness and shape. The diameter of the viewing circle/hole, its' thickness and if the sides of the hole needs to be painted, is all relative to the size of the value segment, and to the distance between the viewer and the subject they are viewing. The preferred size of the viewing circle/hole will optimally isolate the area of the artist's subject from the interference of surrounding values and colors. For the invention prototype, as handheld devices (embodiments in ⅛^{th}″ thick wood strip and the relatively flat linen paper, as applied to the clear acrylic tray cover 3) the diameter of the viewing circle was approximately 3/16 inch to ¼ inch within a 1″ to 1 & ⅛″ wide and tall value step.

The Artist Palette, Paint Storage, Preservation and Compositional system 1 is made in any dimensions preferably, to fit within pochade style (sometimes referred to as, pochade box) easels while making *optimal use of the palette area available in those variously sized pochade easels and may also be set on a flat surface such as a table or atop a French easel drawer. The invention is made in a multitude of dimensions and shapes including, but not limited to, the traditional oval shaped palette with a thumbhole often used with French easels. The invention is made in a multitude of shapes and sizes to fit into the interior of pochade style easels (sometimes referred to as pochade box easels) and the invention will be made in any dimensions to fit within the pochade box while simultaneously making *optimal use of the palette area available inside pochade easels that are offered in a multitude of sizes within and across pochade easel brands such as, but not limited to, the common sizes offered for example: 10×12 inches; 12×16″ ; 14×18″; 11×14″; 9×10″; 9×12″; 8×10″. The pochade box depths vary within and across brands for example, ranging from ½″ to 1 & ¾″ depths. It should be understood that the Artist Palette, Paint Storage, Preservation and Compositional system 1 will require the direct measurement of a multitude of pochade boxes in order to ascertain the most common dimensions for the actual length, width and depths to be used in the production of the invention trays.

The Artist Palette, Paint Storage, Preservation and Compositional System 1 tray cover 3 and bottom 5 are smooth, “glass like” undivided surfaces both of which can be used as a smooth surface paint palette 5 and may involve the use of preferably, impact modified or general purpose acrylics or glass or other optically clear materials. The tray cover preferably fits uniformly over or within the tray bottom and is kept closed with the use of a nylon or other fiber, covered rubber band. The invention may incorporate another closing device such as a latch or fit together sealing lid and may include an optional gasket. The invention may incorporate a device to attach the tray cover to the pochade box or tripod to increase its convenience or its functions. Future production of the invention may include the addition of or provision of an anti-slip material such as a thin rubber strip that the consumer could adhere to the tray bottom most likely for use with placement of the tray on top of a French easel drawer or other flat surface.

The Artist Palette, Paint Storage, Preservation and Compositional system 1 prototype is constructed of an impact modified acrylic sheet (known as PMMA, Polymethyl methacrylate) that can withstand temperatures to −20 degrees Fahrenheit, which enables the paint preservation method accomplished through freezing temperatures. Because it's a thermoplastic and softens under extremely high temperatures, acrylic can be formed to virtually any shape. Incredibly durable, acrylic is a suitable solution over a broad temperature range, and has superior weathering properties compared to other plastics. The prototype is made from an impact modified acrylic in a 0.080 inch thickness and the invention may also be made in multiple thicknesses such as, but not limited to, 0.125; 0.080; 0.093 or commonly referred to measures of 1/16^{th} or ⅛^{th} inch. While it is intended that the invention will be produced for use with various Pochade Box Easels, other uses are contemplated which require a wide variety of shapes and sizes for the Artists Palette, Paint Storage, Preservation and Compositional system 1.

Optimal use of the palette area suggests maximizing the use of the palette space in pochades using a flat, undivided, smooth glass like surface such as the general purpose acrylic (PMMA) sheets artists typically cut and insert as a palette surface into their pochade easels. Optimal use of the palette surface may include, but is not limited to, using materials such as the general purpose acrylics, or the impact modified acrylic used for this invention prototype as well as other PMMA's and possibly, polycarbonates.

### How to Use the Invention/How it Works and What it Does

The Artist Palette, Paint Storage, Preservation and Compositional system 1 modifies, improves and combines individual artist tools/functions into one working product in a unique way not previously provided. This invention moves seamlessly between artists' active functions to paint storage and preservation and back again.

The artist removes the nylon coated rubber band, or similar fastener, and lifts the tray cover off to apply their paint to the palette 5. Paint can be applied immediately before a painting session or in preparation for a future painting session FIG. 2 in which case the prepped tray is again closed by replacing the tray cover and optionally, using the rubber band or similar fastener and it is placed into a freezer for preservation. When the invention has paint on it, it is preferable to store the invention in a refrigerator or freezer. This method preserves the paint for future use and does so for a longer duration than having paint in a covered container at room temperature. Paint is preserved by slowed oxidation and evaporation in freezing temperatures of household refrigerator freezers. This preservation method is common knowledge for use with oil paints however I discovered it also preserves acrylics between painting sessions by putting it in the freezer.

With this invention, when it's time for the next painting excursion, the artist simply removes the Artist Palette, Paint Storage, Preservation and Compositional system 1 from the freezer to take with them. They may choose to put the invention into their pochade box or into a separate container or carrying device such as a tote bag or a cooler is convenient since artists usually pack beverages and meals when they will be out all day. The cool temperatures continue preserving the paint on hot summer days. The artist opens their pochade box FIG. 4 (and if the invention isn't already in the pochade box, they place the invention into the pochade box) and remove the tray cover and they are ready to paint. Immediately ready to paint without needing to squeeze paint from tubes they've carried and or without needing to scrape and transfer paint piles from some other storage container/s.

Preferably, The Artist Palette, Paint Storage, Preservation and Compositional System 1 has a uniformly fitting tray cover 3—with a 9 step *value scale/the Value and color isolator 2—and a tray bottom 5, both of which are optically clear which provides many advantages and integrates multiple functions into one utilitarian invention for artists. The Value and color isolator 2 is embodied in two forms for this invention, one being applied to a strip of wood or other suitable material and the other being as it is applied to the clear tray cover 3. The reasons for two forms of embodiment for the Value and color isolator 2 is that each lends itself for different situations and intents that will be covered as I explain how the Artist Palette, Paint Storage, Preservation and Compositional system 1 is used and the functions it affords. *The term “value” refers to relative lightness to darkness from white to black with gray tones in between. Artists look for and judge values (and colors) in specific areas. They make value comparisons and determinations throughout the subject they are painting and throughout the whole of a painting they are analyzing.

The Artist Palette, Paint Storage, Preservation and Compositional system 1's optically clear cover 3 can be used to sketch and explore compositional options of the artist's subject. This is done by removing the tray cover, holding it up to eye level with arm extended, and the artist views their subject through the clear tray cover. The artist indicates the subject they are viewing and explores various compositions with dry erase markers. Upon this clear tray cover, artists can also apply a compositional grid method of their choice (for example, gridding thirds for focal areas or marking center points to avoid symmetry, such as equal spacing or sizing of elements in a painting. This exploration of possible compositions is a common art task done quickly to help artists work out potential problems and to make choices that best suit their intent for their painting in a temporary manner before beginning a painting. Due to features afforded by the improved, clear material used to make this invention, artists now can also incorporate color options into these quick exploratory compositions on the tray cover because paint (as well as dry erase markers) can be applied and readily removed.

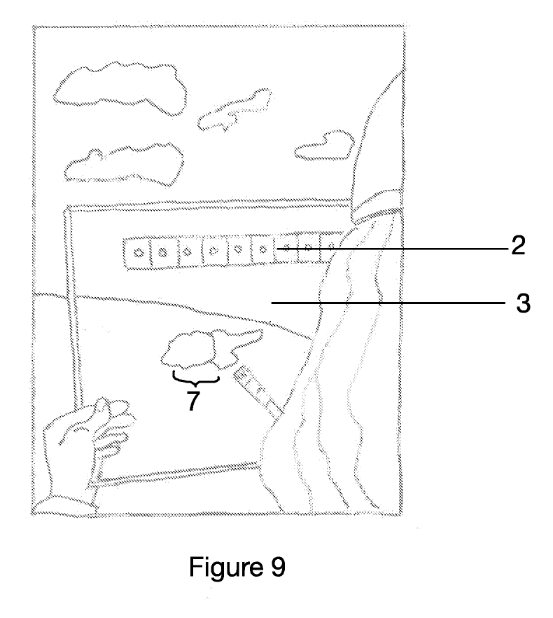

The Artist Palette, Paint Storage, Preservation and Compositional system 1's optically clear cover 3 enables the artist to mix and apply the artists custom paint mixes 7 literally upon the colors of their chosen subject as they are seen through the clear cover FIG. 9. This unique feature provides immediate visual, comparative feedback to the artist about their color mixes to their subject. Such immediacy makes color mixing and adjustments decidedly easier and more accurate for the artist. Similarly, the artist can explore changes they may want to make to an existing painting by applying color mixes onto the clear tray cover as it is held in front of their painting, thus allowing a trial and error process to find what works before applying the change to the painting.

The Artist Palette, Paint Storage, Preservation and Compositional system 1's clear tray bottom 5 keeps the option open for artists to mix paint upon the wood tone of a traditional wooden, hand held palette or on the wood tone of a pochade box as viewed through the clear acrylic bottom 5 or to mix paint against a mid-value gray by simply slipping a gray paper between the tray bottom 5 and a wooden surface such as a traditional wooden palette or a pochade box. Having this option open, enabled by a clear tray bottom, is helpful because some instructors want students to mix paint against a wood tone while others teach to mix upon a mid-value gray.

The Value and color isolator 2 helps the artist form and apply more reliable and accurate value judgments of what they are viewing through the clear viewing holes in each of the nine value steps. The relatively small clear holes enable the artist to isolate very specific areas which is essential to one's ability to accurately determine value. If the viewing shape does not enclose the isolated area to be analyzed or if the viewing shape is too big relative to the size of the value step then other adjoining lights and darks of the subject enter into the viewer's field of vision and obscure the value identification.

To use the Value and color isolator 2 hold it in front of you and position it so you can view the isolated area of your subject that you want to assess through the clear viewing hole. To hone in on the subject area you want to assess, move the Value and color isolator 2 toward you to expand the view or move it away from you to narrow the view. Also, move the Value and color isolator 2 side to side along the value scale over the isolated color you've chosen to analyze, asking yourself does this value step/segment appear lighter or darker than the color I'm viewing? Move along the value scale until the value step that surrounds the viewing hole you are looking through appears to be neither markedly lighter nor darker than the isolated color you are assessing in your subject. Stated another way, when the value and the color appear to nestle together, you are on target.

The Value and color isolator 2 helps the artist avoid mistakes in a painting such as painting a shadow area too dark. For example, on a bright sunny day an artist may misguidedly paint a tree shadow in too dark a value because when seen next to very strongly lit areas, the shadow may strike the eye as very dark. By using this Value and color isolator 2, the artist is able to view the shadow area apart from, and uncontaminated by, adjoining lights that obscure the visual truth of that shadow. Now through the clear viewing holes the artist can compare and better judge the true value and color of that shadow as it actually appears when it is isolated and therefore, not skewed by competing values.

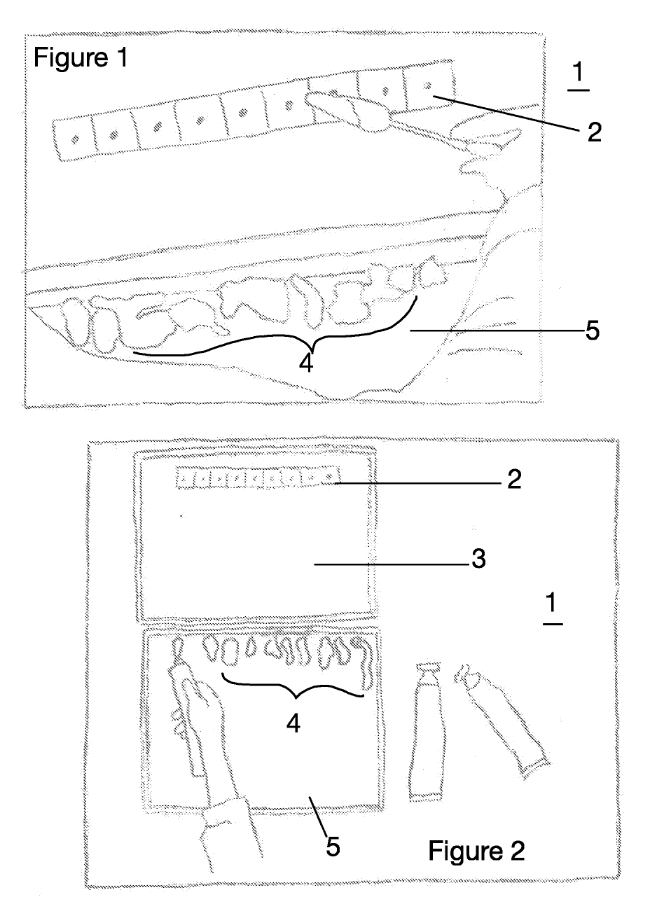

The Value and color isolator 2, in its strip form can be temporarily taped to the pochade box lid below the canvas FIG. 1 and above the paint palette 5 enabling the artist to compare and evaluate paint mixes against values on the wooden strip 2 in the same light as the painting and palette 5. The strip form also affords it the portability and durability to store it with brushes in a brush case for use when painting. These features also make it an easily portable tool that can be taken to art galleries and museums. It functions as an aid to study and increase one's understanding of Master paintings. For example, one can use the Value and color isolator 2 to see subtle value transitions that the Master painters used to create convincing form (shape and volume); to make relative value comparisons between areas depicted in light and those in shadow as well as, what happens in that shadow as it appears closest to the light and what the value changes are as that shadow moves away from the light.

The tray with the cover attached, stores and preserves paint on the working palette (in a freezer or refrigerator). The preservation method works for artists using oil paints, water mixable oils, acrylic paints including open acrylics and a wide variety of paints. The tray with cover fits into any pochade shape including but not limited to the multiple sized pochade box easels already available to consumers, in *custom fits that maximize the ability to make optimal use of the palette area available in pochade boxes. The tray—with the cover attached, will in most cases, fit inside the closed pochade box FIG. 4 such as exemplified with the invention prototype within a 12×16 pochade box. This feature increases ease of portability and reduces the weight of gear for the artist who is now able to leave heavy paint tubes behind in the studio or car. Generally, the tray and cover together fit inside closed pochade boxes. However, the pochades with narrow depths (for example, ¾″) and that have interior (vs external) hardware which lead to multiple protrusions into the pochade box, will not fit as well. However, even in such cases, the tray with the cover on will optimally fit into the open pochade boxes. This is an important feature because it allows the artist to protect the paint on their palette 5 from wind and from the heat of the sun by partially closing the pochade box lid to shade the covered tray when they take occasional breaks during all day paint outs or workshops. Another advantage of the invention 1 being simultaneously, the working palette 5 as well as the storage and preservation system is that the artist can store the closed tray in a cooler to further preserve paint during all day or multiple day paint outs.

The invention is good for the environment by reducing the waste of unused paint and it saves the artist money. Money is saved by reusing unused paint (vs. throwing it away—an unfortunately, very common practice). An example of how unused paint gets wasted, many artists throw away unused paints because they find the transfer back and forth from their acrylic sheet they've installed in their pochade box, to a separate existing prior art product for paint preservation, to be too cumbersome and time consuming. Another common occurrence where unused paint are wasted occurs when artists inadvertently forget to clean unused paint from their acrylic sheet in their pochade box; it dried and becomes unusable. The invention makes saving unused paint and reusing it far easier and less time consuming for the artist because it eliminates the need to scrape and transfer paint piles. How: the invention is made of acrylic sheet—it provides the very same palette 5 material oil and plein air painters almost exclusively use because of the smooth uninterrupted/undivided palette 5 expanse that can stand up to metal palette knife use and that same surface allows artists the typical practice of quickly yet gently pulling and sliding from pure pigment piles 4 down into mixed paint pools 7. Furthermore, the invention is also optimally sized making the most of available palette area which is of utmost importance to artists. These combined characteristics essentially eliminate the need to transfer paint back and forth between the acrylic sheet cuts they currently install into their pochade boxes and onto and from other storage/preservation devices that do not make optimal use of the available palette area within variously sized pochade easels in order to reuse unused paint.

Once the Artist Palette, Paint Storage, Preservation and Compositional system 1 is made available, all these factors combine to make being environmentally and economically conscientious an easy and practical matter for artists. The invention further reduces expenses for the artist because the invention facilitates more ease in using the far more economical large tubes of paint. Because large paint tubes are quite heavy, particularly when transporting 8-12 tubes of paint, many artists use small, lighter weight tubes of paint which cost nearly twice as much per milliliter to use than the large economy sized tubes. With this invention, artists now can squeeze paint from the heavier economy sized tubes FIG. 2 (at home or in their studio or car) onto the invention prior to transporting gear into class or walking to their outdoor painting site. Even if they choose to bring along a few small tubes in the event they run out of a frequently used color, they've still greatly reduced the weight load of art gear transported and they've minimized their use of the more costly paint that comes in small tubes.

Another advantage of using the Artist Palette, Paint Storage, Preservation and Compositional system 1 is that it saves the artist time just when they need it most. While it is understood that with any product there is the initial input—in this case, squeezing paint from tubes onto a palette 5—which you will do less of if you have saved unused paint for future use. Significantly, this invention saves artists' time at a crucial point in time for the artist trying to capture the fleeting light effects of outdoor painting. This really can't be overstated. In plein air painting you typically get 2-3 hours to do a whole painting because the light and shadows change so fast so yes, time is of that much essence. Additionally, for the student artist that uses this invention they are now ready to paint upon arrival FIG. 4 allowing them focus on the art instructor's painting demonstration and instruction rather than scrambling to load their palette and risk missing important information.

Another advantage of this invention is that the Palette, Paint Storage, Preservation and Compositional system 1 allows the artist to preserve specific color mixes 7 exactly as they laid them out on their palette 5 in loose and broken color (which cannot be accomplished if you have to scrape and pile up paint mixes in order to fit unused paint onto smaller storage or preservation devices) until their next painting session where they can, brush in hand, literally pick up where they left off. (It is understood that thin mixes will not stay open (soft and pliable) as long as pigment/paint piles but the freezer does prolong the open work time of loosely mixed paint pools. Additionally, the optically clear tray cover provides immediate feedback/visibility to the artist regarding the pigment load status on their palette 5 at any given time. Many artists paint less than daily and if several days pass before your next painting session and you have previously stored unused paint, there's no longer any need to remove an opaque cover just to see what's there. This unexpected feature is quite convenient for artists.

### How To Make It

I have a homemade prototype that provides a physical embodiment of my invention in the material it will preferably be made in, an impact modified acrylic. The Artist Palette, Paint Storage, Preservation and Compositional system 1 is constructed of optically clear acrylic or equivalent or similar material. The Artist Palette, Paint Storage, Preservation and Compositional system 1 comprises an optically clear upper tray cover and a optically clear lower tray bottom/base. Both trays include a relatively large flat base and one or more sides. The sides are attached to the base to completely surround an area on one side of the base. To build this invention prototype, the material was cut into pieces for the tray base/bottom and for the tray cover and into strips that comprised the tray walls/sides. The material components were fastened together. The acrylic cement “glue” that was used to join the acrylic cuts together for the prototype was a solvent cement but, and other products could be used such as mixed solvent cements, polymerizable cements, or likely less effective means such as common household epoxys, glues or tapes. The top is shaped to be congruent with the bottom and sized so that one or more sides fit over or within the one or more side of the bottom. The top and bottom are sized so that when the top is placed over or within the bottom, the sides significantly reduce fluid communication with the outside of the resulting enclosed volume.

### Value And Color Isolator 2

The Value and color isolator 2, enables the viewer to assess the color and value (the lightness or darkness) of a specific, isolated area made possible by drilling holes into a grayscale painted flat strip. It was necessary to color the interior surface of the viewing holes in the same value as the area in which the viewing hole was located due to the thickness of the strip. This was so because the side of the hole in a thick (for example ⅛^{th} inch) strip enters the viewer's field of view which would skew the viewer's value assessment if it were not painted in the same value as the surrounding area. The thinner the substrate, the less this effect interferes with the value comparison and assessment. The relative dimensions and distance will determine whether or not the viewing hole should be painted. For example, the ⅛^{th} inch thick strip with 3/16″ to ¼″ diameter holes required that the interior surface of the hole be painted in the same shade/value as the surrounding area to achieve accurate measurements, while the 3/16″ to ¼″ diameter hole in the thin strip did not. The advantage of the Value and color isolator 2 application using a thick strip is that it is both portable and strong enough to fit in a typical artists brush case or in a purse when someone studies paintings at an art museum or gallery.

I later painted and then cut holes into a painted linen cloth paper swatch and I applied it to the Artist Palette, Paint Storage, Preservation and Compositional system 1 with an over-laminate. The relative thinness of the linen cloth substrate obviated the need to color the inner surface of the viewing hole. I applied the Value and color isolator 2 to clear acrylic because it allows the artist to apply color/paint mixes directly onto the value scale in order to make comparisons and test their value assessments. In this embodiment, artists can remove the paint from the acrylic, a property that is not afforded by the application of a value scale on paper or wood substrates.

### Method of Application of the Value and Color Isolator 2 to the Invention Prototype:

The visual image, the Value and color isolator 2, was applied to oil primed linen cloth paper with artists oil paints. Once the oil painted values dried thoroughly, strips were cut from linen cloth paper. The over laminate and viewing holes/clear circles were cut in the middle locations of each value step segment. The over-laminate adhered the Value and color isolator 2 to the invention prototype on the outside surface of the tray cover with the visual image facing down to the inside of the tray cover. The image was applied to the outside surface so that when the inside surface of the tray cover is used, paint mixes can be applied to the value steps on the image without any contact to the over laminate and underlying painted canvas strip.

### Alternative Methods of Manufacture:

The future method of production will likely be accomplished through thermoforming PMMA's, including impact modified acrylic sheets, likely by curtain (drape), drape form or cold formed or vacuum thermoforming or injection molding, to produce the product in dimensions that preferably, *fully fit the interior palette areas of a multitude of pochade style easel sizes while allowing for enough room for the artist to insert and remove the covered tray. Other methods of production may include, adjoining cut pieces and strips of acrylic sheets and additional methods of affixing components may include ultrasonic welding or dip/soak cementing. Production may also entail the use of polycarbonates.

### Anticipated Methods of Application of the Value and Color Isolator 2

Alternate methods of application (than what was used for the prototype) of the grayscale value strip with clear holes image may include the visibility of this grayscale value strip with clear holes image from both sides of the tray cover. Application of Value and color isolator 2 image may include the application of permanent inks or screen printing or a high quality, perhaps exterior paint with a high percentage, up to 100%, of acrylic binders or, it may include a commercially made UV and water resistant, temperature tolerant vinyl film graphic, possibly with a UV and water resistant or waterproof, temperature tolerant laminate overlay.

I claim:

1. A Value and color isolator 2 comprising a bar with holes spaced at regular intervals with a region surrounding each of said holes, each of said regions colored in differing intensities of color and value, with coloration of each region chosen to establish a reference along a value scale, and the diameter of the holes chosen to make comparison of a value and color intensity through the hole easier by isolating specific areas of the artists subject, in order to match to the surrounding region.

2. The Artist Palette, Paint Storage, Preservation and Compositional System comprising:
a) a top with edges and
b) a bottom with edges sized so that when the top is placed over or within the bottom, the sides significantly reduce fluid communication with the outside of the resulting enclosed volume.

3. The Artist Palette, Paint Storage, Preservation and Compositional System of claim 2 wherein the top is transparent.

4. The Artist Palette, Paint Storage, Preservation and Compositional System of claim 2 wherein the bottom is transparent.

5. The Artist Palette, Paint Storage, Preservation and Compositional System of claim 2 wherein both the top and bottom are transparent.

6. The Artist Palette, Paint Storage, Preservation and Compositional System of claim 2 further comprising a value and color isolator.

7. The Artist Palette, Paint Storage, Preservation and Compositional System of claim 2 wherein both the top and bottom are smooth, “glass like” undivided surfaces.

8. The Artist Palette, Paint Storage, Preservation and Compositional System of claim 2 wherein both the top and bottom are preferably made of from impact modified or general grade acrylics or polycarbonates or glass or other optically clear materials.

9. Artist Palette, Paint Storage, Preservation and Compositional System of claim 2 wherein the top preferably fits uniformly over or within the bottom.

10. Artist Palette, Paint Storage, Preservation and Compositional System of claim 2 wherein the top and bottom fit and optimally fill the interior of at least one pochade box easel.

11. The Artist Palette, Paint Storage, Preservation and Compositional System of claim 2 wherein the closed top and bottom are made preferably of an impact modified acrylic sheet or other acrylics or glasses or clear materials that preferably withstand freezing temperatures for paint storage and preservation.

12. The Artist Palette, Paint Storage, Preservation and Compositional System of claim 2 further comprising a closing device.
